(19) United States
(12) Patent Application Publication
(10) Pub. No.: US 2010/0106451 A1
(43) Pub. Date: Apr. 29, 2010

(54) Zero-Point Correction Apparatus and Method for an Angular Speed Sensor

(76) Inventors: Hisayoshi Sugihara, Aichi-ken (JP); Yataka Nonomura, Aichi-ken (JP); Motohiro Fujiyoshi, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/989,710

(22) PCT Filed: Aug. 1, 2006
(86) PCT No.: PCT/IB2006/002087

§ 371 Date: Jan. 30, 2008

(30) Foreign Application Priority Data
Aug. 1, 2005 (JP) 2005-223508

(51) Int. Cl. G01P 3/44

(52) U.S. Cl. 702/147

(57) ABSTRACT

An angular sensor (10) is provided in a mobile body. A first setter (14) performs determination regarding the standstill state on the basis of whether or not the variation width of the angular speed is less than or equal to a predetermined value. A standstill determiner (20) determines whether or not the standstill state has continued beyond a determination time. An n−i sum-total averaging unit (34) calculates a sum-total average of (n−i) number of pieces of data obtained by excluding, from n number of pieces of data input during a period determined as a continuation of the standstill state, i number of pieces of data that are output immediately before the end timing of the period, and determines it as a zero-point offset. A zero-point corrector (36) performs the zero-point correction of the output value of the angular speed sensor (10), and outputs the corrected value to an output unit (28).

### FIELD OF THE INVENTION

The invention relates to an angular speed sensor and, more particularly, to zero-point correction of an angular speed sensor provided in a mobile body such as a robot or the like.

### BACKGROUND OF THE INVENTION

Acceleration sensors and yaw rate sensors are used for the attitude control of a mobile body such as a robot or the like. Where three orthogonal axes are an x-axis, a y-axis, and a z-axis, the accelerations in the directions of the axes are detected by three acceleration sensors, and the yaw rates about the axes are detected by three yaw rate sensors. The angles about the axes, or the attitude angles (the roll angle, the pitch angle, and the yaw angle), are obtained by time integration of the outputs of the yaw rate sensors.

Japanese Patent Application Publication No. 2004-268730 discloses a technology of performing a attitude control through the use of the acceleration data and attitude data output by a gyro sensor.

However, as the attitude angle is found by integration of the angular speed, the offset and the drift of the angular speed sensor are gradually accumulated. Therefore, if the offset and like are large, the attitude angle gradually forms a very large value, which increases and diverges with time. This can be prevented simply by using an angular speed sensor with small offset and drift. However, such an angular speed sensor is large, heavy, and costly.

### DISCLOSURE OF THE INVENTION

It is an object of the invention to provide an apparatus and a method that is capable of detecting the attitude angle of a mobile body while preventing the accumulation of integration errors and that adopts a simple construction without employing a costly high-accuracy angular speed sensor.

A first aspect of the invention relates to a zero-point correction apparatus of an angular speed sensor provided in a mobile body. This zero-point correction apparatus comprises: detection means for detecting a standstill state of the mobile body; calculation means for calculating an average value of output values of the angular speed sensor during the standstill state; and correction means for correcting a zero point of the angular speed sensor to the average value.

In this zero-point correction apparatus, the standstill state of the mobile body provided with the angular speed sensor is detected, and the output values of the angular speed sensor during the standstill state are used to correct the zero point of the angular speed sensor. Since during the standstill state of the mobile body, the output value of the angular speed sensor should be zero in principle, the output values output from the sensor during the standstill state form a zero-point offset. Therefore, the zero point is corrected by the average value of output values of the angular speed sensor during the standstill state, thereby preventing accumulation of errors in the attitude angle obtained by integration of the angular speed.

The standstill state of the mobile body may be detected from at least one of a variation width of outputs of the angular speed sensor and a variation width of outputs of an acceleration sensor provided in the same mobile body. Since it is desirable that the standstill state continue for at least a certain time in order to secure a good accuracy in the zero-point correction, the zero point may be corrected by the average value of sensor output values during the standstill state that continues for at least a predetermined determination time.

A second aspect of the invention relates to a zero-point correction method of an angular speed sensor provided in a mobile body. The method includes the step of determining whether the mobile body is in a standstill state; the step of calculating an average value of output values of the angular speed sensor during the standstill state; and the step of correcting a zero point of the angular speed sensor to the average value.

According to the invention, it is possible to correct the zero point of an angular speed sensor, prevent accumulation of integration errors, and detect the attitude angle of a mobile body while adopting a simple construction.

### BRIEF DESCRIPTION OF THE DRAWINGS

The foregoing and further objects, features and advantages of the invention will become apparent from the following description of exemplary embodiments with reference to the accompanying drawings, wherein like numerals are used to represent like elements and wherein:

FIG. 1 is a construction block diagram of an embodiment;

FIG. 2 is a timing chart showing a correction value calculation method;

FIG. 3 is a timing chart showing an improved correction value calculation method;

FIG. 4 is a timing chart showing a further improved correction value calculation method;

FIG. 5 is a timing chart showing a further improved correction value calculation method;

FIG. 6 is a timing chart showing a further improved correction value calculation method;

FIG. 7 is a construction block diagram of another embodiment; and

FIGS. 8A and 8B show a construction block diagram of still another embodiment.

### DETAILED DESCRIPTION OF PREFERRED EMBODIMENTS

Embodiments of the invention will be described hereinafter with reference to the drawings.

### First Embodiment

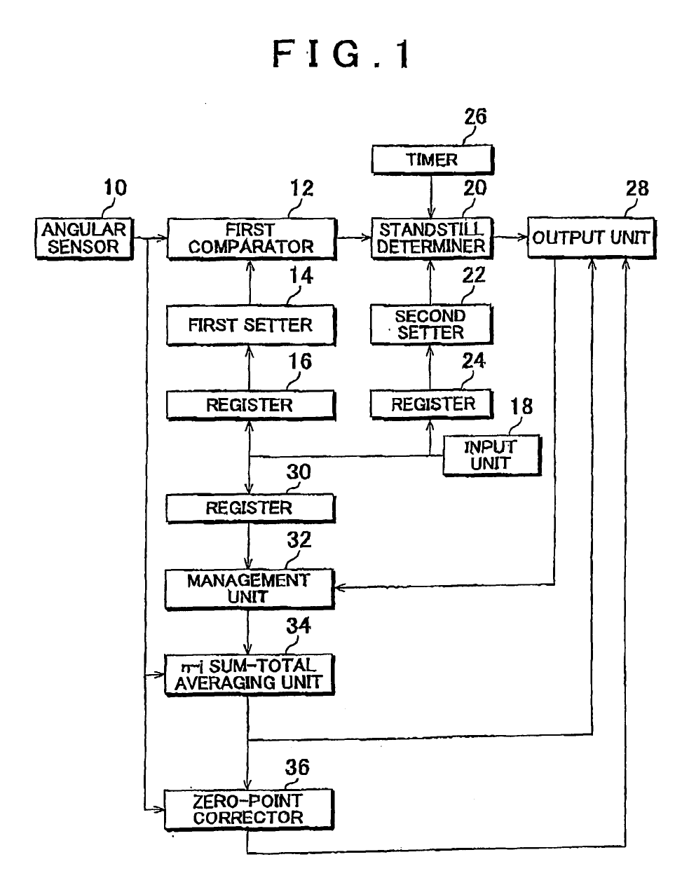

FIG. 1 shows a construction block diagram of this embodiment. An angular sensor 10 is provided at a predetermined position in a mobile body such as a robot or the like, and detects the angular speed of the mobile body. For example, the angular sensor 10 adopts an xyz orthogonal coordinate system as a sensor coordinate system, and detects the angular speeds about the axes, that is, the x-axis, the y-axis and the z-axis. The angular sensor 10 outputs the detected angular speeds to a first comparator 12.

The first comparator 12 compares in magnitude the variation width (fluctuation width) of input angular speeds with a predetermined range. The predetermined range is set by a first setter 14. The first setter 14 may set a fixed range as the predetermined range. It is also permissible to provide a construction such that a range set by a register 16 is set as the predetermined range, and a user is allowed to set a desired range in the register 16 through the use of an input unit 18, as shown in FIG. 1. The first comparator 12 outputs the result of the magnitude comparison of the variation width of the angular speed and the predetermined range to a standstill determiner 20. For example, the first comparator 12 outputs to the standstill determiner 20 a signal HI when the variation width of the angular speed is within the predetermined range, and a signal LOW when the variation width of the angular speed exceeds the predetermined range.

The standstill determiner 20 inputs the result of comparison from the first comparator 12, and detects the time (start time to) at which the output of the angular sensor 10 enters a predetermined range. The standstill determiner 20 also detects the time (end time te) at which the output of the angular sensor 10 deviates from the predetermined range. The standstill determiner 20 also measures the elapsed time (continuation time tok) from the start time to. The standstill determiner 20 determines whether or not the continuation time tok has exceeded a predetermined determination time tos. If the continuation time tok has exceeded the determination time tos, the standstill determiner 20 outputs a start timing signal Tst to an output unit 28. The predetermined determination time tos is supplied from a second setter 22. The setting contents of the second setter 22 are appropriately set at a register 24. After outputting the start timing signal, the standstill determiner 20 outputs an end timing signal Ten to the output unit 28 at the time (end time te) at which the output of the angular sensor 10 deviates from the predetermined range. Furthermore, the standstill determiner 20 measures the elapsed time (continuation time tsk) from the start timing signal Tst. When the continuation time tsk exceeds a correction end time toe, the standstill determiner 20 outputs the end timing signal Ten to the output unit 28 in a forced fashion.

The output unit 28 outputs the start timing signal Tst and the end timing signal Ten to a management unit 32. The management unit 32 receives the start timing signal Tst, and starts an averaging process at an n−i sum-total averaging unit 34. Furthermore, the management unit 32 receives the end timing signal Ten, and ends the averaging process at the n−i sum-total averaging unit 34. Furthermore, the management unit 32 indicates a −i process time toi of the n−i sum-total averaging unit 34, to the n−i sum-total averaging unit 34 with reference to a register 30. Still further, the management unit 32 commands a zero-point corrector 36, via the n−i sum-total averaging unit 34, to update a zero-point correction value with the n−i sum-total average if the continuation time tsk is greater than or equal to a predetermined correction minimum time toh. If the continuation time tsk is less than the predetermined correction minimum time toh, the management unit 32 determines that sufficient accuracy is not obtained; therefore, the zero-point correction value at the zero-point corrector 36 is not updated.

The n−i sum-total averaging unit 34 has a register that retains i number of pieces of data corresponding to a predetermined time, and starts retaining i number of pieces of data upon an instruction from the management unit 32. The n−i sum-total averaging unit 34 waits until i number of pieces of data have been retained. When the (i+1)th piece of data is received, the n−i sum-total averaging unit 34 starts the computation of a sum-total average, starting with the first piece of data. In this manner, the computation of a sum-total average of the first to (n−i)th data is repeatedly performed. Upon an end instruction from the management unit 32, the n−i sum-total averaging unit 34 outputs the (n−i) sum-total average value to the zero-point corrector 36. The zero-point corrector 36 corrects the zero point by updating the zero point with the input average value. The computation of a sum-total average of the first to (n−i)th pieces of data in this manner is adopted for the following reasons. That is, if a sum-total average of the first to nth pieces of data is calculated, pieces of data obtained after the angular speed actually begins to vary are included in the computation, so that the accuracy thereof declines. Thus, by using the first to (n−i)th pieces of data up to a time point that is the predetermined time toi prior to te in obtaining a sum-total average, a zero-point correction value can be accurately calculated.

A zero-point correction value calculation process of this embodiment will be described hereinafter with reference to timing charts of the output value of the angular speed sensor.

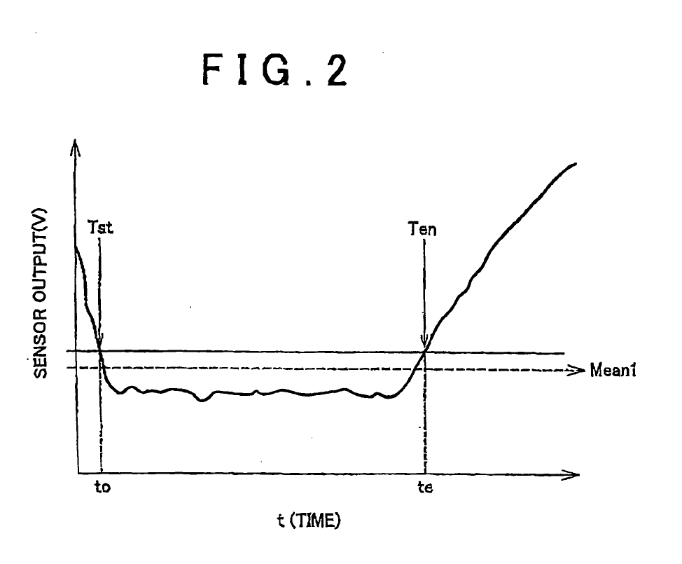

FIG. 2 shows time-dependent changes in the angular speed output from the angular sensor 10. In FIG. 2, the horizontal axis represents time (s), and the vertical axis represents the angular speed (rad/s). As for basic computation, a sum-total average computation for a correction value is started at the start time to, and the sum-total average computation for a correction value ends at the end time te. The start timing signal Tst and the end timing signal Ten are output at times to, te, respectively. The sum-total average Mean1 from the n−i sum-total averaging unit 34 is output to the zero-point corrector 36, thus updating the zero-point correction value.

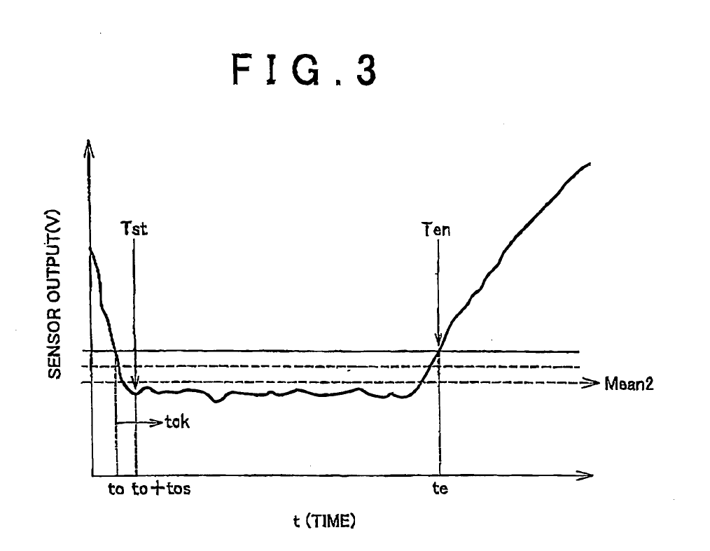

FIG. 3 shows an improved zero-point correction value calculation method. In the same situation as in FIG. 2, considering the stability of the correction, the start timing signal Tst is output to the output unit 28 so as to start the sum-total average computation for a correction value, not at the start time to, but when the continuation time tok exceeds the predetermined determination time tos (i.e., at the time to+tos). At the end time te, the end timing signal Ten is output to the output unit 28, so as to end the sum-total average for a correction value. The correction value of the zero-point corrector 36 is updated with the calculated correction value Meant. Therefore, occurrence of an unnecessary correction can be prevented. Since unstable data immediately following the beginning of a standstill is not included in the averaging process.

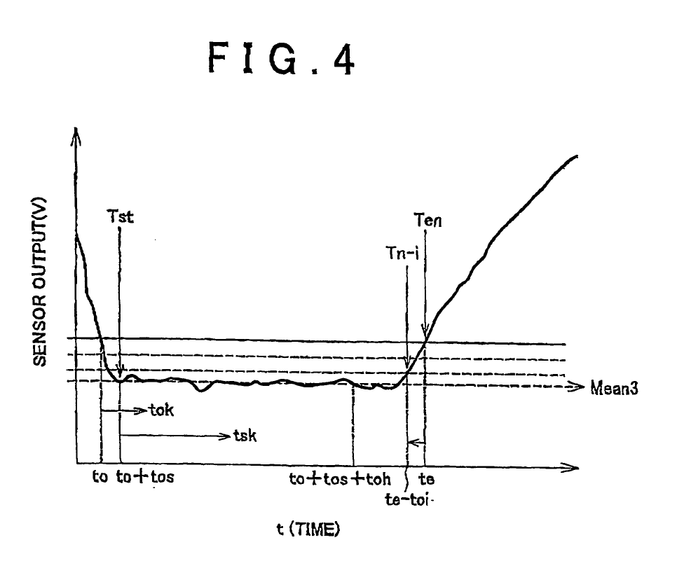

FIG. 4 shows a further improved zero-point correction value calculation method. In substantially the same situation as in FIG. 3, with respect to data at a timing (i.e., time te−toi) which is a predetermined time, that is, the −i process time toi, prior to the end time te, the sum-total average computation (n−i sum-total average computation) is performed, and the n−i sum-total average value Mean3 is output to the zero-point corrector 36. Tn−i in FIG. 4 is a timing signal that the management unit 32 gives as an instruction to the n−i sum-total averaging unit 34. Therefore, a data group with very low accuracy that precedes the end time to can be excluded from the sum-total average value, and the accuracy can be improved. The time toi or the number of output values that are output from the angular sensor 10 which correspond the time toi may be changed by the n−i sum-total averaging unit 34.

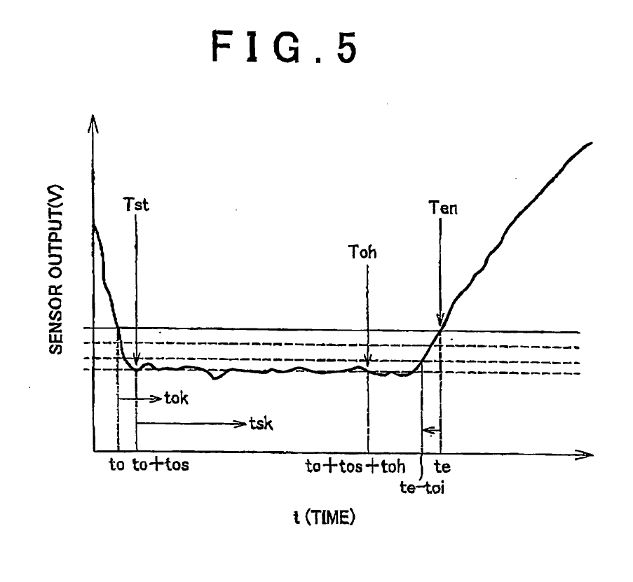

FIG. 5 shows a further improved zero-point correction value calculation method. In the same situation as in FIGS. 2 to 4, the continuation time tsk is measured, and when the continuation time tsk is equal to or greater than the correction minimum time toh, a command to update the zero-point correction value with the sum-total average is given to the zero-point corrector 36 via the n−i sum-total averaging unit 34. Therefore, the number of samples needed for maintaining a good accuracy be secured, and the correction value update with good accuracy becomes possible.

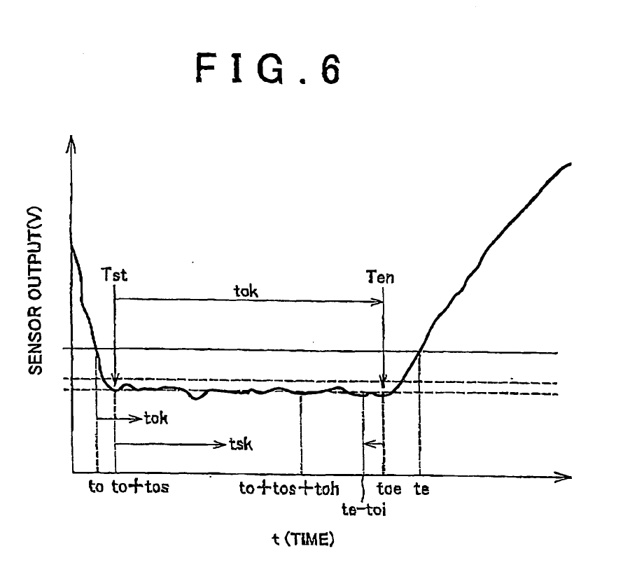

FIG. 6 shows a further improved zero-point correction value calculation method. In the same situation as in FIGS. 2 to 5, when the continuation time tsk reaches a predetermined time, that is, the correction end time toe, the standstill determiner 20 outputs the end timing signal Ten in a forced fashion, thereby ending the standstill correction. Therefore, a zero-point correction value having a necessary accuracy can be obtained in the predetermined time, and thus the zero-point correction value can be updated. In these calculation methods, the determination time tos is about 0.1 s to 1 s, and may be set at, for example, about 0.3 s. Although the shorter the determination time, the earlier the switch to the standstill correction, the setting of the determination time depends on the stabilization responsiveness of the mobile body. The determination time is set relatively long for a mobile body that needs a relatively long time to reach a standstill. However, if the determination time is set excessively long (e.g., 5 s or longer), the frequency of the switch to the standstill correction declines, so that the accuracy as a whole declines.

Furthermore, it is appropriate that the correction minimum time toh be about 1 s to 10 s. The correction minimum time toh may be about 8 s. Setting the correction minimum time toh to as long a time as possible achieves improved accuracy of the correction value. However, if the correction minimum time toh is set excessively long, the frequency of carrying out the standstill correction declines, so that the accuracy as a whole declines. Therefore, the correction minimum time toh, too, is set in conformity with the actions of the mobile body.

The −i process time toi is about 0.1 s to 1 s, and may be about 0.3 s. Although shorter −i process times toi generally increase the amount of standstill correction data, the setting of the −i process time toi depends on the activation responsiveness of the mobile body. The −i process time toi is set relatively long for a mobile body that needs a relatively long time to activate. Considering that the setting thereof to an excessively long time (e.g., about 5 s) inconveniently reduces the amount of data for use for the standstill correction, and brings about a decline in the accuracy of the correction value contrary to the original purpose, the −i process time toi may be set at an appropriate value.

The correction end time toe is about 1 s to 300 s, and may be about 3 s. Generally, longer end times toe improve the correction value accuracy. However, if the correction end time toe is set excessively long, the frequency of carrying out the standstill correction declines, so that the accuracy as a whole declines. Therefore, it is recommendable to set the correction end time toe in conformity with the actions of the mobile body. The correction end time toe is set to a time that is longer by at least the −i process time toi than the correction minimum time toh.

Incidentally, the first comparator 12, the standstill determiner 20, the management unit 32, the n−i sum-total averaging unit 34, the zero-point corrector 36, etc., can be formed by a microprocessor.

### Second Embodiment

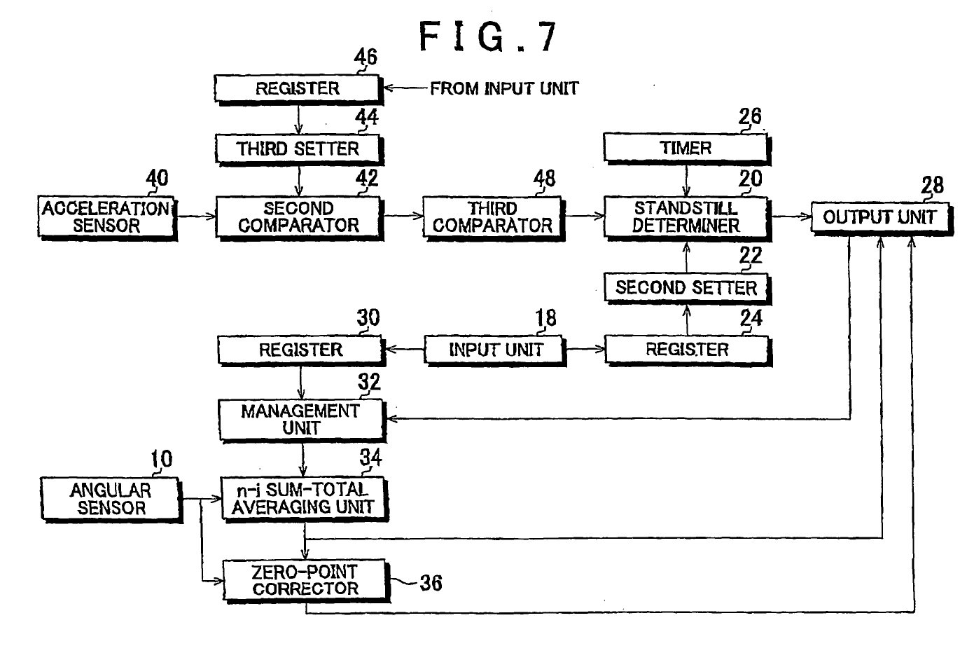

FIG. 7 shows a construction block diagram of this embodiment. In the embodiment of FIG. 1, the angular speed from the angular sensor 10 is used for determination regarding the standstill state of the robot. In the second embodiment, however, the acceleration from an acceleration sensor provided in the same robot is used for determination regarding the standstill state.

An acceleration sensor 40 detects the accelerations in the directions of the axes of the robot, that is, the x-axis, the y-axis and the z-axis, and outputs the accelerations to a second comparator 42.

The second comparator 42 compares in magnitude a predetermined range set in a third setter 44 and the variation width of the accelerations, and outputs the result of comparison to a third comparator 48. The predetermined range is set by the third setter 44. The third setter 44 may set a fixed range as the predetermined range. It is also permissible to provide a construction such that a range set by a register 46 is set as the predetermined range, and a user is allowed to set a desired range in the register 46 through the use of an input unit, as shown in FIG. 7.

The third comparator 48 determines whether or not the absolute values of the accelerations at the start timing and the end timing are substantially equal to the gravitational acceleration (e.g., 9.797072 m/s², at the international reference point at Kyoto University. The term “substantially” covers the gravitational acceleration ± allowable error, and the allowable error is set factoring in the offset that is expected to occur in the acceleration sensor 40), or whether or not the gravitational acceleration during that period is substantially equal to the gravitational acceleration. If these accelerations are not substantially equal to the gravitational acceleration, the third comparator 48 determines that the robot is not in the standstill state. On the other hand, if these accelerations are substantially equal to the gravitational acceleration, the third comparator 48 determines that the robot is in the standstill state, and outputs the result of determination to the standstill determiner 20. The subsequent processes are similar to those in the first embodiment. The use of the acceleration for the determination regarding the standstill state facilitates the detection of the translational motion and the vibrational motion, and improves the zero-point correction accuracy of the angular sensor 10.

### Third Embodiment

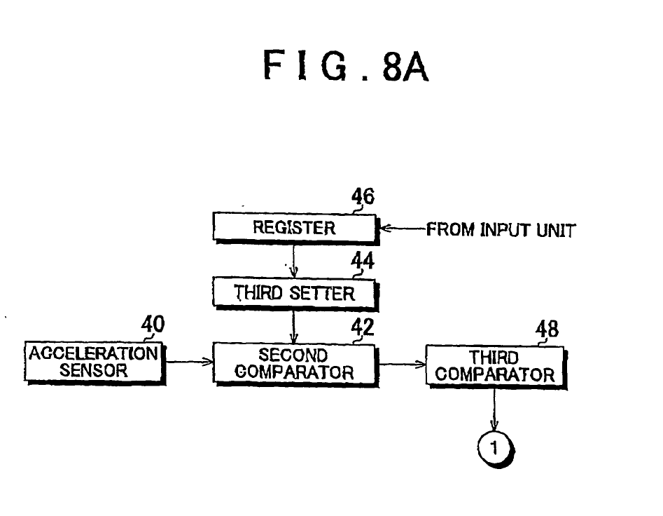

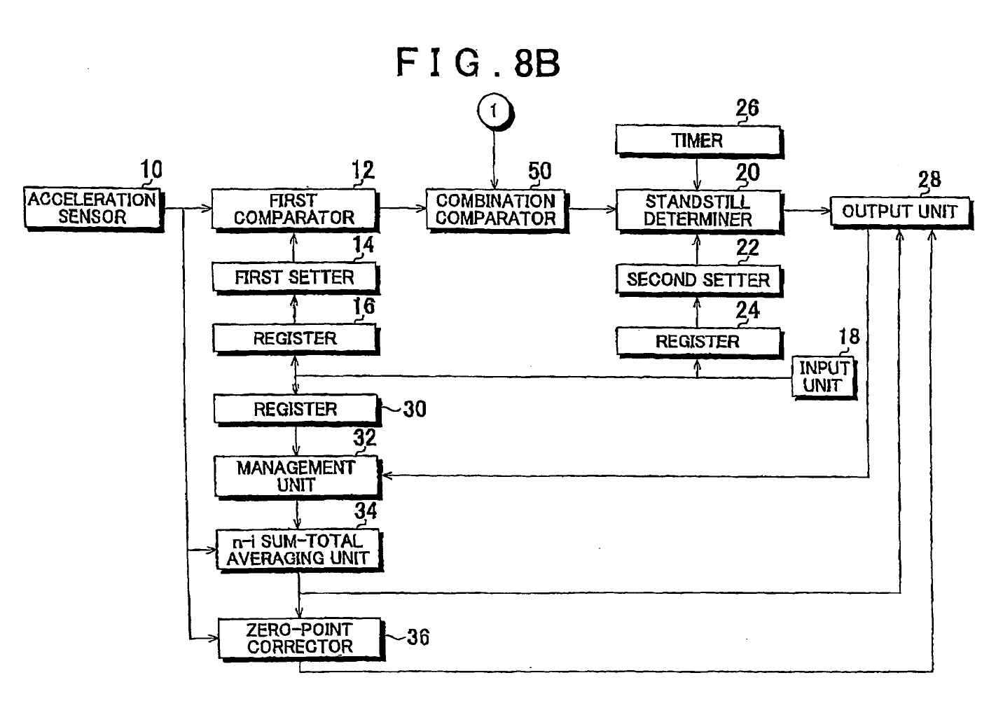

FIG. 8A and 8B show a construction block diagram of this embodiment. In this embodiment, the angular speed and the acceleration are both used determination regarding the standstill state.

The construction of determining the standstill state by using the angular speed is similar to that shown in FIG. 1. However, a first comparator 12 outputs the result of comparison to a combination comparator 50, not to a standstill determiner 20.

On the other hand, the construction of determining the standstill state by using the acceleration is similar to that shown in FIG. 7. However, a third comparator 48 outputs the result of comparison to the combination comparator 50, not to the standstill determiner 20.

The combination comparator 50 inputs the result of comparison from the first comparator 12, and the result of comparison from the third comparator 48, and determines that the robot is in the standstill state if both the results of comparison are within certain ranges, and outputs the result of determination to the standstill determiner 20. The subsequent processes are similar to those in the first embodiment.

In the third embodiment, the determination regarding the standstill state is performed on the basis of the combination of the angular speed and the acceleration, so that the translational and rotational movements of the robot can be monitored. Therefore, the presence of the standstill state can be determined with even higher accuracy, so that the zero-point of the angular sensor 10 can be corrected very favorably.

While embodiments of the invention have been described above, the invention is not limited thereto, but may be variously changed.

For example, although in FIGS. 1 to 8B, the determination time tos for determining that there is a significant standstill state can be adjusted by a user setting a desired value in the register 24 via the input unit 18, the determination time tos may be automatically set, instead of being manually set by a user. Furthermore, instead of the determination time, the combined determination criteria at the combination comparator 50 may be changed. In the case where the zero-point correction is not performed even after the predetermined time elapses, for instance, it may be determined that the robot is in the standstill state if it is determined that one of the angular speed and the acceleration is in the standstill state, instead of it being determined that the robot is in the standstill state if it is determined that both the angular speed and the acceleration are of the standstill state. Thus, the determination condition may be relaxed so as to secure early execution of the zero-point correction. The registers 16, 24, 30, 46 may be configured by one device.

1. A zero-point correction apparatus of an angular speed sensor provided in a mobile body, comprising:
detection means for detecting a standstill state of the mobile body;
calculation means for calculating an average value of output values of the angular speed sensor during the standstill state; and
correction means for correcting a zero point of the angular speed sensor to the average value.

2. The apparatus according to claim 1, wherein the calculation means calculates an average value of output values of the angular speed sensor during a period from a start timing of the standstill state till a time point earlier than an end timing of the standstill state.

3. The apparatus according to claim 2, further comprising means for variably setting the predetermined time.

4. The apparatus according to claim 1, wherein the calculation means calculates an average value of output values of the angular speed sensor that are obtained by excluding a predetermined number of output values that are output immediately before an end timing of the standstill sate from output values that are output during a period from a start timing of the standstill state till the end timing of the standstill state.

5. The apparatus according to claim 4, further comprising means for variably setting the predetermined number of output values.

6. The apparatus according to any one of claims 1 to 5, wherein the detection means detects the standstill state based on whether or not a variation width of output values of the angular speed sensor is less than or equal to a first predetermined width.

7. The apparatus according to any one of claims 1 to 5, wherein the detection means detects the standstill state based on whether or not a variation width of output values of an acceleration sensor provided in the mobile body is less than or equal to a second predetermined width.

8. The apparatus according to any one of claims 1 to 5, wherein the detection means detects the standstill state based on whether or not a variation width of output values of the angular speed sensor is less than or equal to a first predetermined width and a variation width of output values of an acceleration sensor provided in the mobile body is less than or equal to a second predetermined value.

9. The apparatus according to claim 7 or 8, wherein the detection means detects the standstill state based on whether or not an absolute value of an output value of the acceleration sensor is substantially equal to a gravitational acceleration.

10. The apparatus according to any one of claims 6 to 9, further comprising means for variably setting at least one of the first predetermined width and the second predetermined width.

11. The apparatus according to any one of claims 1 to 10, wherein the detection means detects the standstill state that continues for at least a predetermined determination time.

12. The apparatus according to claim 11, further comprising means for variably setting the predetermined determination time.

13. A zero-point correction method of an angular speed sensor provided in a mobile body, comprising:
determining whether the mobile body is in a standstill state;
calculating an average value of output values of the angular speed sensor during the standstill state; and
correcting a zero point of the angular speed sensor to the average value.

14. A zero-point correction apparatus of an angular speed sensor provided in a mobile body, comprising:
a detector that detects a standstill state of the mobile body; and
a controller that calculates an average value of output values of the angular speed sensor during the standstill state and corrects a zero point of the angular speed sensor to the average value.
